(19) United States
(12) Patent Application Publication
(10) Pub. No.: US 2012/0042837 A1
(43) Pub. Date: Feb. 23, 2012

(54) DOG LEASH SYSTEM WITH CONVERTIBLE COLLAR AND HARNESS

(76) Inventor: Axelle VANDENBULCKE, Miami, FL (US)

(21) Appl. No.: 12/858,703

(22) Filed: Aug. 18, 2010

(51) Int. Cl. A01K 27/00; A44B 11/02

(52) U.S. Cl. 119/792; 24/164

(57) ABSTRACT

A dog leash system with convertible collar and harness comprising: a leash line having a first end and a second end, a first clip permanently attached to the first end of the leash and a second clip permanently attached to the second end of the leash, a handle, the first rotatable clip removably connected to the handle, a buckle, a first collar and a second collar, the first collar strap routed through the buckle when using the dog leash system as a collar based system, and the first collar strap and the second collar strap routed through the buckle space between the second bar and the lower surface of the buckle when using the dog leash system as a harness based system, the first collar strap being connected to the second collar strap to form two loops that fit around different portions of a dog's chest.

### BACKGROUND OF THE INVENTION

This invention relates to a dog leash system that provides for converting between a collar based system and a harness based system and more particularly to a dog leash system including a buckle that provides for converting a collar used around a dog's neck to a harness used around the dog's chest.

A dog leash normally attaches directly to a collar designed to fit solely around a dog's neck. Alternatively, the dog leash attaches directly to a harness designed to fit solely the around the dog's chest.

If the dog leash is presently connected to a collar around the dog's neck, the leash must first be disconnected from the collar and then reconnected to a separate harness around the dog's chest. Similarly, if the leash is presently connected to a harness around a dog's chest, the leash must first be disconnected from the harness and then reconnected to a separate collar around the dog's neck. In other words, existing leashes require a separate collar and harness in order to have the flexibility of attaching the leash around either the dog's neck or the dog's chest.

Moreover, because existing dog leashes connect directly to the collar or harness, the material at the point of connection on the collar and harness is likely to wear and eventually break.

Accordingly, one purpose of this invention is to provide a dog leash system with convertible collar and harness that converts from a collar secured around a dog's neck to a harness comprised of two collars secured around the dogs chest without requiring a harness unit that is separate and distinct from the collars.

It is a further purpose of this invention to provide a buckle which allows for the conversion of a collar to the harness and that provides for attaching a leash line to either a collar or a harness.

### BRIEF DESCRIPTION OF THE INVENTION

A dog leash system with convertible collar and harness comprising: a leash line having a first end and a second end, a first clip permanently attached to the first end of the leash and a second clip permanently attached to the second end of the leash, a handle, the first rotatable clip removably connected to the handle, a buckle including an upper surface, a lower surface and a pair of inserts on opposing edges, a first bar rotatably and permanently connected to the pair of inserts on opposing edges of the buckle, the first bar rotating across and offset from the upper surface of the buckle, a second bar fixedly and permanently attached to the lower surface of the buckle, a second bar fixedly and permanently attached to the lower surface of the buckle, the second bar offset from the lower surface of the buckle so as to provide a space between the second bar and the lower surface of the buckle, the height of the space being at least equal to the height of two stacked collar straps and the width of the space being at least equal to the width of a collar strap, a first collar and a second collar, each collar comprised of a collar strap, a clasp at one end of each collar strap and holes at the other end each collar strap, the clasps and the holes combining to secure one end of the collar strap to the other end of the collar strap, the first collar strap routed through the space between the second bar and the lower surface of the buckle when using the dog leash system as a collar based system, and the first collar strap and the second collar strap routed through the space between the second bar and the lower surface of the buckle when using the dog leash system as a harness based system, the first collar strap being connected to the second collar strap to form two loops that fit around different portions of a dog's chest.

A buckle used in a dog leash system with convertible collar and harness comprising: a buckle including an upper surface, a lower surface and a pair of inserts on opposing edges, a first bar rotatably and permanently connected to the pair of inserts on opposing edges of the buckle, the first bar rotating across and offset from the upper surface of the buckle, a second bar fixedly and permanently attached to the lower surface of the buckle, the second bar offset from the lower surface of the buckle so as to provide a space between the second bar and the lower surface of the buckle, the height of the space being at least equal to the height of two stacked collar straps and the width of the space being at least equal to the width of a collar strap.

A dog leash system with convertible collar and harness comprising: a leash line having a first end and a second end, a first clip permanently attached to the first end of the leash and a second clip permanently attached to the second end of the leash, a handle, the first rotatable clip removably connected to the handle, a buckle including an upper surface, a lower surface and a pair of inserts on opposing edges, a first bar rotatably and permanently connected to the pair of inserts on opposing edges of the buckle, the first bar rotating across and offset from the upper surface of the buckle, a second bar fixedly and permanently attached to the lower surface of the buckle, the second bar offset from the lower surface of the buckle so as to provide a space between the second bar and the lower surface of the buckle, the height of the space being at least equal to the height of two stacked collar straps and the width of the space being at least equal to the width of a collar strap, a collar comprised of a collar strap, a clasp at one end of the collar strap and holes at the other end of the collar strap, the clasps and the holes combining to secure one end of the collar strap to the other end of the collar strap, the collar strap being routed at least once through the space between the second bar and the lower surface of the buckle when using the dog leash system as a collar based system and the collar strap being routed at least twice through the space between the second bar and the lower surface of the buckle when using the dog leash system as a harness based system, the collar strap forming two loops that fit around different portions of a dog's chest.

### BRIEF DESCRIPTION OF THE DRAWINGS

FIG. 1 shows the individual components of the dog leash system with convertible collar and harness of the present invention.

FIG. 2 shows the leash component of the dog leash system with convertible collar and harness of the present invention.

FIG. 3 shows the individual collar straps of the dog leash system with convertible collar and harness of the present invention.

FIGS. 4A and 4B show the buckle of the dog leash system with convertible collar and harness of the present invention.

FIG. 5 shows the buckle of the dog leash system with convertible collar and harness of the present invention configured as a collar.

FIG. 6 shows the dog leash system with convertible collar and harness of the present invention configured as a collar around a dog's neck.

FIG. 7 shows the buckle of the dog leash system with convertible collar and harness of the present invention configured as a harness.

FIG. 8 shows the dog leash system with convertible collar and harness configured as a harness around a dog's chest.

### DETAILED DESCRIPTION OF THE INVENTION

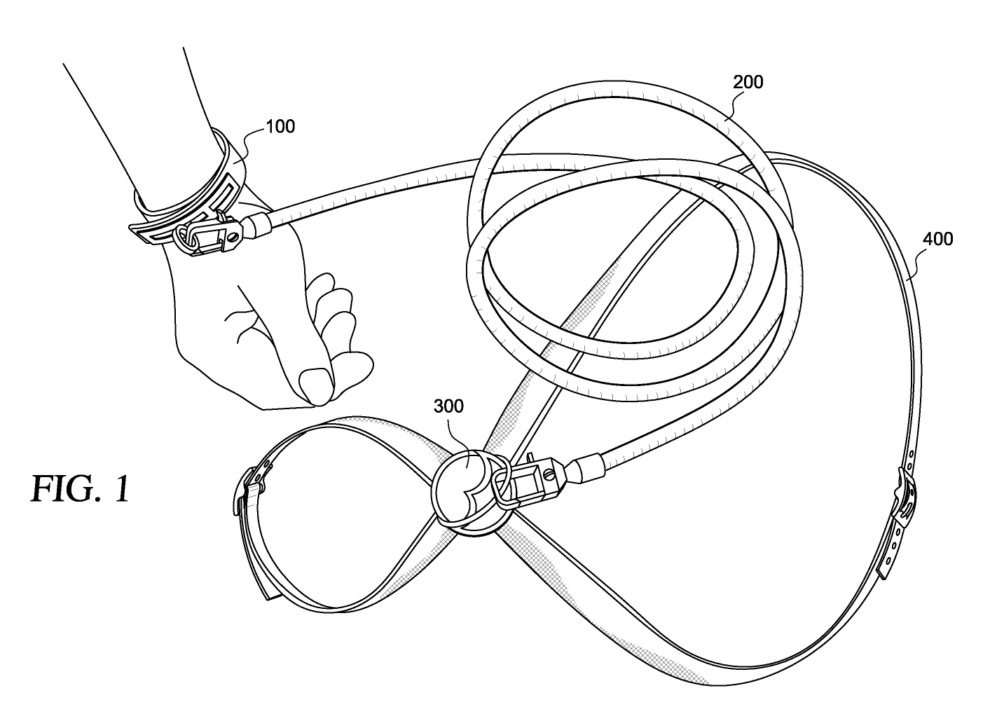

FIG. 1 shows the individual components of the dog leash system with convertible collar and harness of the present invention. As shown, the dog leash system is comprised of a wrist band or handle 100, a leash 200, a buckle 300 and individual collar straps configured as a harness 400. One end of the leash 200 is detachable connected to the wrist or handle. The other end of the leash is detachable connected to the buckle 300. The harness 400 is comprised of individual collar straps routed through the buckle 300.

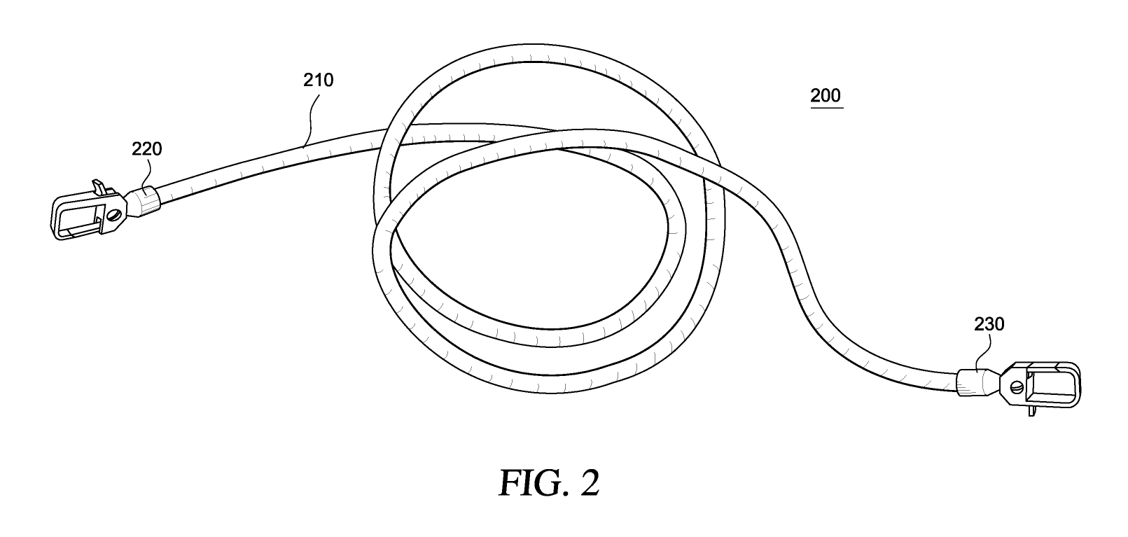

FIG. 2 shows the leash of the dog leash system with convertible collar and harness of the present invention. As shown, the leash 200 is comprised of a leash line 210 with rotatable clips 220 and 230 permanently attached to each end of the leash line. The leash line 210 is made of any flexible material strong enough to withstand the tension provided by a dog pulling on the leash 200, such flexible material including leather, plastic, cloth and metal wire. Although the clips 220 and 230 are shown as rotatable, they may be of any configuration which allows for attaching an end of the leash line 210 to another component. The clips 220 and 230 are made of any solid material strong enough, as with the leash line 210, to withstand the tension provided by a dog pulling on the leash 200.

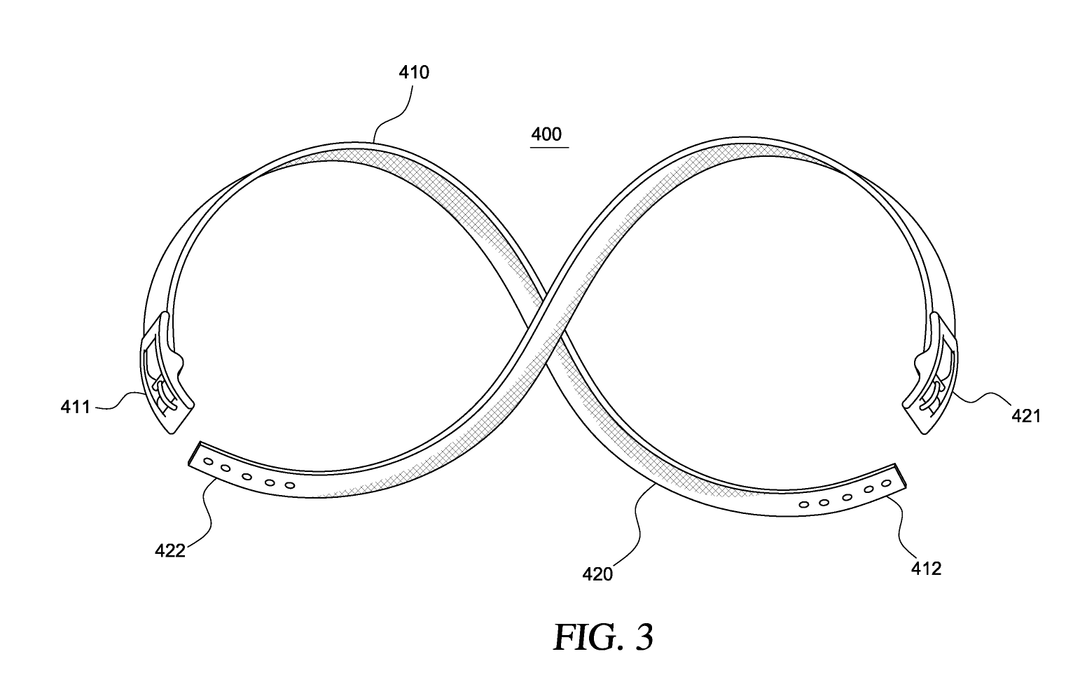

FIG. 3 shows the individual collars of the dog leash system with convertible collar and harness of the present invention. As shown, a first collar strap 410 includes a permanently attached clasp 411 at one end and corresponding clasp holes 412 at the other end. Similarly, a second collar strap 420 includes a permanently attached clasp 421 at one end and corresponding clasp holes 422 at the other end. Each collar is designed for use around a dog's neck and the clasp and corresponding clasp holes on each collar allow for adjustably securing the collar around the dog's neck.

As also shown in FIG. 3, in a harness configuration, the first collar strap 410 is attached to the second collar strap 420 at one end using the first collar strap's clasp 411 and the second collar strap's holes 422. Similarly, the second collar strap 420 is attached to the first collar strap at the other end using the second collar strap's clasp 421 and the first collar strap's holes 412. The harness configuration is formed by twisting the attached first collar strap 410 and second collar strap 420 to form two loops, each of which will be attached around a different portion of the dog's chest. The size of each loop is adjustable secured using the clasp of one collar strap's clasp and the holes on the other collar strap.

While the dog leash system with convertible collar and harness of the present invention is shown with harness comprised of two connected collars, the harness may also be comprised of a single collar with a collar strap of sufficient length to form two loops around the different portions of the dogs chest.

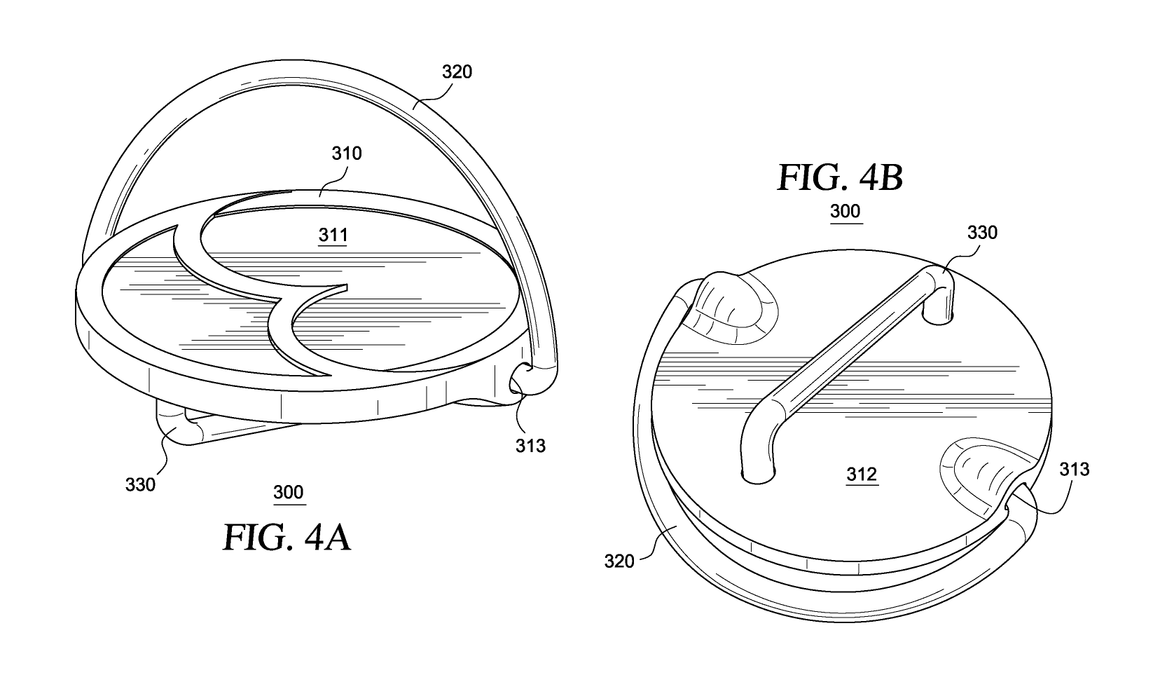

FIGS. 4A and 4B show the buckle of the dog leash system with convertible collar and harness of the present invention.

FIG. 4A shows the upper surface of the buckle. As shown, the buckle 300 is round with an outer circumference 310 and a flat upper surface 311. The upper surface 311 may include an embossed design. The outer circumference 310 includes a pair of opposing inserts 313. A rigid semicircular shaped rod 320 is rotatably attached to the buckle using the pair of opposing inserts 312. The diameter of the rod 320 is such that the rod 312 lines up smoothly against the outer circumference 310 when rotated to a position coplanar with the buckle 300.

FIG. 4B shows the lower surface of the buckle. As shown, the lower surface 312 is flat. A rigid bar 330 is fixedly attached to the lower surface 312 at a position raised off of the lower surface 312. The space between the lower surface 312 and the fixed bar 330 is sufficient to encompass at least the height of two stacked collar straps. The length of the bar 330 is at least equal to the width of a collar strap.

The buckle and its components are made of a rigid material that is strong enough to withstand the tension exerted on the buckle by a dog pulling on the leash. Such materials may include metal, plastic or any combination of such materials.

Although the buckle is shown as round, the present invention encompasses any shape that provides for a first rod that rotates over the upper surface of the buckle and a second rod that is fixedly attached to and removed from the lower surface of the buckle. For example, the buckle may be square shaped with a square shaped first rod rotatably attached to the buckle using a pair of inserts on opposing edges of the buckle and a second rod fixedly attached to and removed from the lower surface of the buckle.

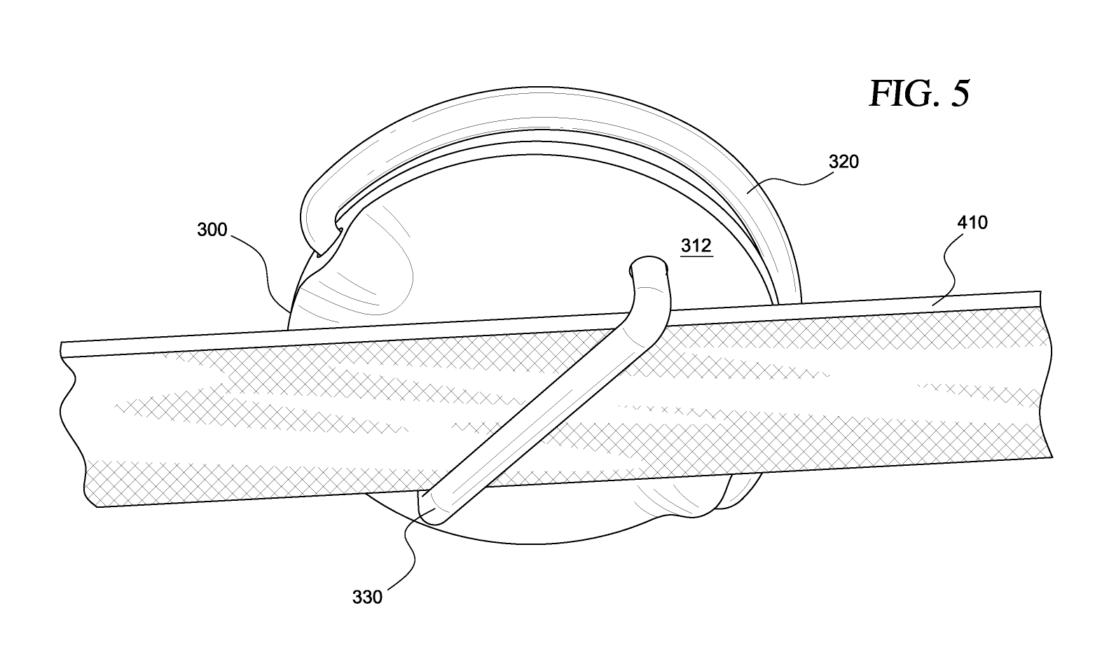

FIG. 5 shows the buckle of the dog leash system with convertible collar and harness of the present invention configured as a collar. As shown, the collar strap 410 is routed through the space in-between the lower surface 312 of the buckle 300 and the rod 330 fixedly attached to the lower surface 312.

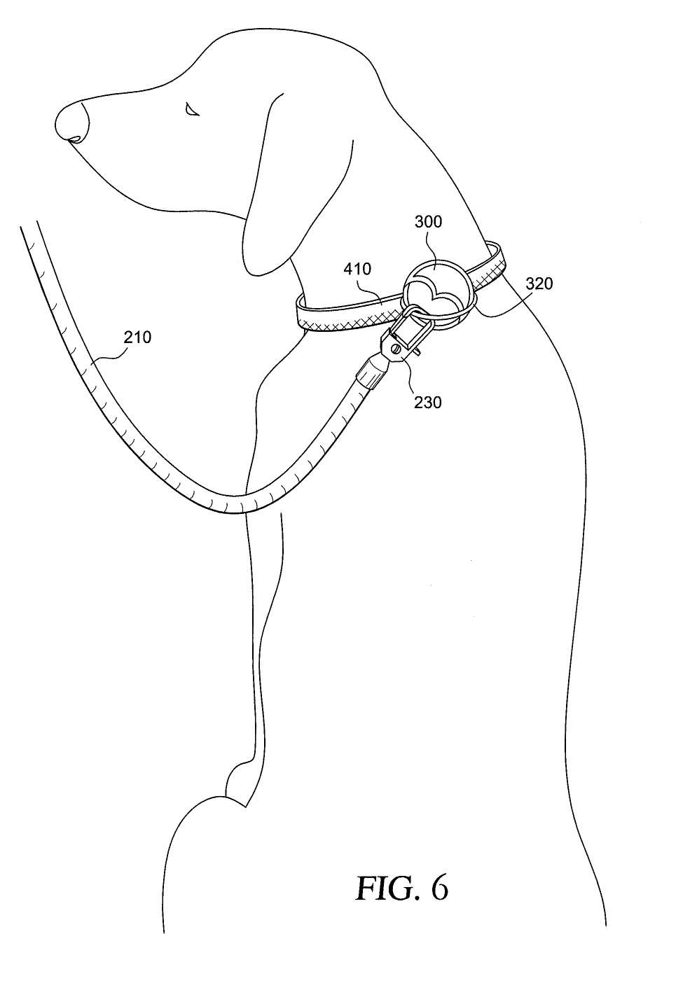

FIG. 6 shows the dog leash system with convertible collar and harness of the present invention configured as a collar around a dog's neck. As shown, when configured as a collar, the buckle 300 sits anywhere on the dog's neck. A single loop extends from the buckle 300 and wraps around the dog's neck where the clasp 411 on one end of the collar strap 410 attaches to the corresponding holes 412 on the other end of the collar strap 410. The rotatable clip 230 at one end of the leash line 210 attaches to the rotatable rod 320 on the buckle 300.

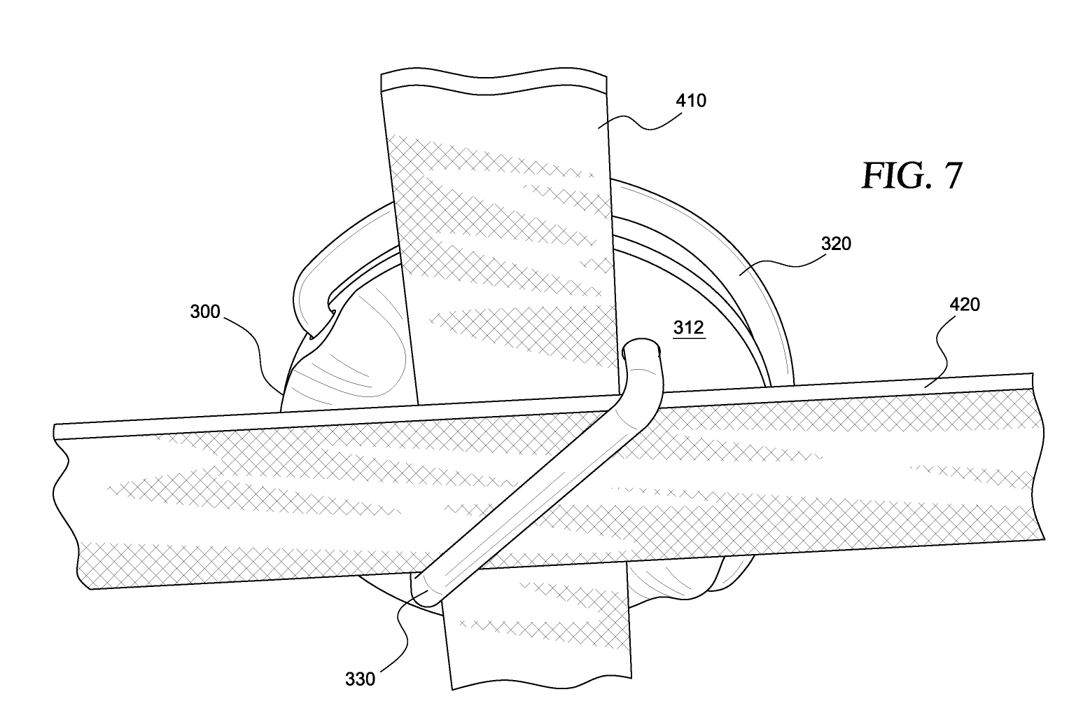

FIG. 7 shows the buckle of the dog leash system with convertible collar and harness of the present invention configured as a harness. As shown, a first collar strap 410 is routed through the space in-between the lower surface 312 of the buckle 300 and the rod 330 fixedly attached to the lower surface 312. Furthermore, a second collar strap 420 is routed through that same space and sits on top of the first collar strap 410.

The buckle 300 provides for a configuration, as shown in FIG. 3, in which the first collar strap 410 and the second collar strap 420 form a harness comprised of two loops, each of which are attached around a different section of the dog's chest. The size of each loop is adjustable using the clasp of one collar strap's clasp and the corresponding holes of the other collar strap.

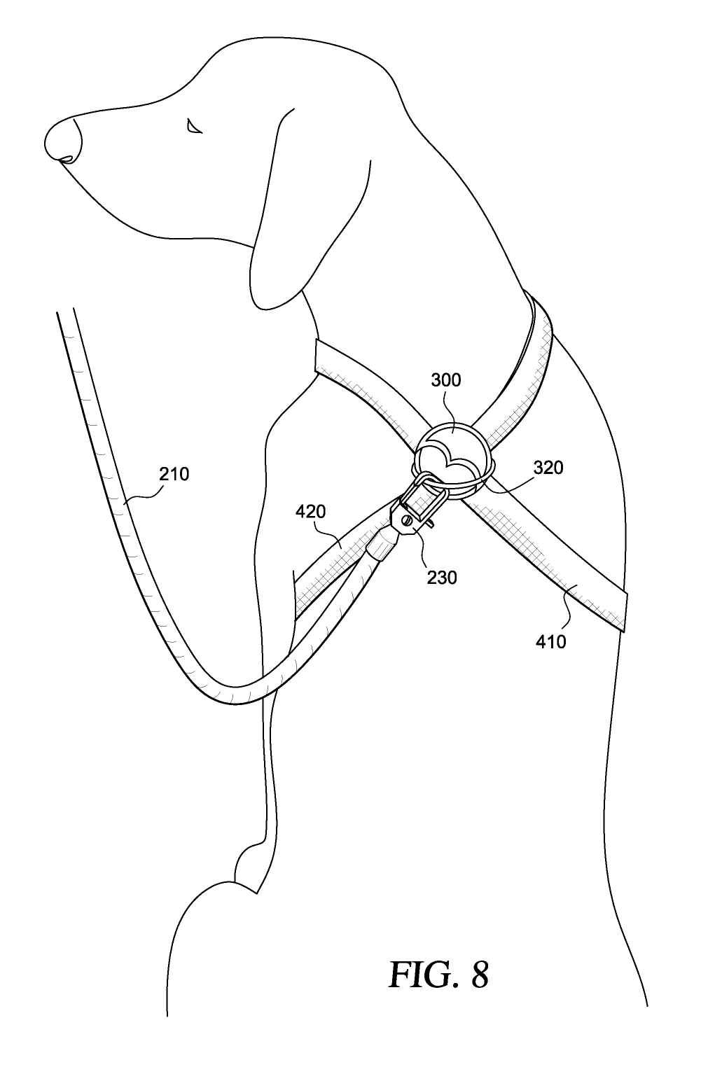

FIG. 8 shows the dog leash system with convertible collar and harness configured as a harness around a dog's chest. As shown, when configured as a harness, the buckle 300 sits on an upper area of the dogs back. The first loop of the harness extends upward from the buckle 300 and wraps around a portion of the dog's chest just above the dog's front legs where the clasp 411 of the first collar strap 410 is attached to the corresponding holes 422 of the second collar strap 420. The second loop extends downward from the buckle 300 and wraps around a lower portion of the dog's chest just below the dog's front legs where the clasp 421 of the second collar strap 420 attaches to the corresponding holes 412 of the first collar strap 410. The rotatable clip 230 at one end of the leash line 210 is attached the rotatable rod 320 on the buckle 300.

In all cases, it is understood that the above-described arrangements are merely illustrative of the many possible specific embodiments which represent applications of the present invention. Numerous and varied other arrangements can be readily devised in accordance with the principles of the present invention without departing from the spirit and scope of the invention.

1. A dog leash system with convertible collar and harness comprising:
a leash line having a first end and a second end;
a first clip permanently attached to the first end of the leash and a second clip permanently attached to the second end of the leash;
a handle, the first rotatable clip removably connected to the handle;
a buckle including an upper surface, a lower surface and a pair of inserts on opposing edges;
a first bar rotatably and permanently connected to the pair of inserts on opposing edges of the buckle, the first bar rotating across and offset from the upper surface of the buckle;
a second bar fixedly and permanently attached to the lower surface of the buckle, the second bar offset from the lower surface of the buckle so as to provide a space between the second bar and the lower surface of the buckle, the height of the space being at least equal to the height of two stacked collar straps and the width of the space being at least equal to the width of a collar strap;
a first collar and a second collar, each collar comprised of a collar strap, a clasp at one end of each collar strap and holes at the other end of each collar strap, the clasps and the holes combining to secure one end of the collar strap to the other end of the collar strap;
the first collar strap routed through the space between the second bar and the lower surface of the buckle when using the dog leash system as a collar based system; and
the first collar strap and the second collar strap routed through the space between the second bar and the lower surface of the buckle when using the dog leash system as a harness based system, the first collar strap being connected to the second collar strap to form two loops that fit around different portions of a dog's chest.

2. The dog leash system with convertible collar and harness of claim 1 wherein the first clip and the second clip are each rotatable.

3. The dog leash system with convertible collar and harness of claim 1 wherein the handle is a wrist strap.

4. The dog leash system with convertible collar and harness of claim 1 wherein the upper surface of the buckle is embossed with a design.

5. The dog leash system with convertible collar and harness of claim 1 wherein the buckle is round.

6. The dog leash system with convertible collar and harness of claim 1 wherein the first rotatable bar is shaped as a semicircle.

7. A buckle used in a dog leash system with convertible collar and harness comprising:
a buckle including an upper surface, a lower surface and a pair of inserts on opposing edges;
a first bar rotatably and permanently connected to the pair of inserts on opposing edges of the buckle, the first bar rotating across and offset from the upper surface of the buckle;
a second bar fixedly and permanently attached to the lower surface of the buckle, the second bar offset from the lower surface of the buckle so as to provide a space between the second bar and the lower surface of the buckle, the height of the space being at least equal to the height of two stacked collar straps and the width of the space being at least equal to the width of a collar strap.

8. The buckle used in a dog leash system with convertible collar and harness of claim 7 wherein the buckle is round.

9. A dog leash system with convertible collar and harness comprising:
a leash line having a first end and a second end;
a first clip permanently attached to the first end of the leash and a second clip permanently attached to the second end of the leash;
a handle, the first rotatable clip removably connected to the handle;
a buckle including an upper surface, a lower surface and a pair of inserts on opposing edges;
a first bar rotatably and permanently connected to the pair of inserts on opposing edges of the buckle, the first bar rotating across and offset from the upper surface of the buckle;
a second bar fixedly and permanently attached to the lower surface of the buckle, the second bar offset from the lower surface of the buckle so as to provide a space between the second bar and the lower surface of the buckle, the height of the space being at least equal to the height of two stacked collar straps and the width of the space being at least equal to the width of a collar strap;
a collar comprised of a collar strap, a clasp at one end of the collar strap and holes at the other end of the collar strap, the clasps and the holes combining to secure one end of the collar strap to the other end of the collar strap;
the collar strap being routed at least once through the space between the second bar and the lower surface of the buckle when using the dog leash system as a collar based system; and
the collar strap being routed at least twice through the space between the second bar and the lower surface of the buckle when using the dog leash system as a harness based system, the collar strap forming two loops that fit around different portions of a dog's chest.

10. The dog leash system with convertible collar and harness of claim 9 wherein the first clip and the second clip are each rotatable.

11. The dog leash system with convertible collar and harness of claim 9 wherein the handle is a wrist strap.

12. The dog leash system with convertible collar and harness of claim 9 wherein the upper surface of the buckle is embossed with a design.

13. The dog leash system with convertible collar and harness of claim 9 wherein the buckle is round.

14. The dog leash system with convertible collar and harness of claim 9 wherein the first rotatable bar is shaped as a semicircle.
